(19) United States
(12) Patent Application Publication
(10) Pub. No.: US 2015/0155641 A1
(43) Pub. Date: Jun. 4, 2015

(54) ELECTRIC WIRE PINCH STRUCTURE

(71) Applicant: Yazaki Corporation, Tokyo (JP)

(72) Inventors: Hajime Kato, Kakegawa-shi (JP); Kazuhiro Tomine, Kakegawa-shi (JP); Takaaki Miyajima, Kakegawa-shi (JP)

(73) Assignee: Yazaki Corporation, Tokyo (JP)

(21) Appl. No.: 14/399,401

(22) PCT Filed: May 7, 2013
(86) PCT No.: PCT/JP2013/063235

§ 371 Date: Nov. 6, 2014

(30) Foreign Application Priority Data
May 7, 2012 (JP) 2012-106275

(51) Int. Cl. H01R 4/48

(52) U.S. Cl. CPC H01R 4/48

(57) ABSTRACT

An electric wire pinch structure of the invention includes a first flat plate including a first aperture into which an electric wire is to be inserted; a second flat plate including a second aperture into which the electric wire is to be inserted; a first stretched area that extends from a first side surface of the first aperture along a direction of insertion of the electric wire; and a second stretched area that extends from a second side surface of the second aperture in the direction of insertion of the electric wire, wherein the electric wire is pinched between the first stretched area and the second stretched area. The electric wire is pinched between the first stretched area and the second stretched area as a result of relative sliding taking place between the first flat plate and the second flat plate.

### TECHNICAL FIELD

The invention relates to an electric wire pinch structure and, more particularly, to an electric wire pinch structure used in a terminal for an electrical connection of a conductor of an electric wire.

### BACKGROUND ART

As shown in FIGS. 5A and 5B, a related art electric wire pinch structure (a clamp terminal) has a flat plate 2 including an aperture 3 into which an electric wire 6 is to be inserted and another flat plate 4 including another aperture 5 into which the electric wire 6 is to be inserted. The flat plates 2 and 4 are slid by means of an urging section, thereby pinching (clamping) the electric wire 6.

### CITATION LIST

### Patent Literature

[PTL 1] Japanese Patent Publication No. JP-A-11-345637

### SUMMARY OF INVENTION

### Technical Problem

As shown in FIG. 6, since the related art electric wire pinch structure (the clamp terminal) effects pinching action by means of edges 8 of the flat plates 2 and 4, an external conductor 7 of the electric wire 6 might be cut. Specifically, the external conductor 7 might be cut by means of shearing force exerted by the edges 8 of the flat plates 2 and 4, which might disrupt an electrical connection between the electric wire pinch structure (the clamp terminal) and the electric wire.

### Solution to Problem

According to one aspect of the present invention, there is provided an electric wire pinch structure comprising:

a first flat plate having a first side surface partly forming a first aperture into which an electric wire is to be inserted;

a second flat plate having a second side surface partly forming a second aperture into which the electric wire is to be inserted;

a first stretched area that extends from the first side surface of the first aperture along a direction of insertion of the electric wire; and

a second stretched area that extends from the second side surface of the second aperture in the direction of insertion of the electric wire, wherein

the electric wire is pinched between the first stretched area and the second stretched area as a result of relative sliding taking place between the first flat plate and the second flat plate a direction orthogonal to a direction of insertion of the electric wire.

According to the configuration, the electric wire is pinched between the flat portion of the stretched area of the first flat plate and the flat portion of the other stretched area of the second flat plate. Therefore, cutting of the electric wire (a conductor), which would otherwise be caused by pinching action, can be impeded. Further, a contact area between the conductor and the respective stretched areas is increased, so that the electrical connection can be reliably established. Thus, reliability of the electrical connection is enhanced. Further, as a result of the respective stretched areas playing a role as guides, the electric wire can be smoothly inserted in a direction of insertion. Also, since the electric wire is reliably inserted in a direction of insertion as a result of the respective stretched areas playing a role as guides, impeding insertion of other electric wires or occurrence of a contact between conductors, which would otherwise be induced when some electric wires intrude into course of others during insertion of a plurality of electric wires.

The first stretched area may penetrate through the second aperture, to thus extend in the direction of insertion of the electric wire.

According to the configuration, the first stretched area penetrates through the second aperture, whereby the first stretched area can move within the second aperture. The movement allows the first stretched area and the second stretched area to pinch the electric wire (the conductor) in response to sliding action of the flat plates.

The electric wire pinch structure may further comprise:

projections that are provided on at least one of a surface of the first stretched area and a surface of the second stretched area to contact the electric wire.

According to the configuration, the pinched electric wire (the conductor) can be fastened reliably as a result of the projections contacting the electric wire (the conductor).

The electric wire pinch structure may further comprise:

an urging section for relatively sliding the first flat plate and the second flat plate.

According to the configuration, providing the urging section makes it possible for the flat plates to bring about relative sliding action. The first stretched area and the second stretched area can pinch the electric wire (the conductor) by dint of urging force in response to sliding action of the flat plates.

### Advantageous Effects of Invention

The electric wire pinch structure of the invention makes it possible to prevent cutting of an electric wire, which would otherwise be caused by damping, and reliably form an electrical connection by an increase in a contact surface of a conductor. Moreover, a stretched area plays a role as a guide, thereby enabling smooth insertion of an electric wire in the direction of insertion.

### BRIEF DESCRIPTION OF DRAWINGS

FIGS. 1A and 1B are drawings showing an example of an electric wire pinch structure (a damp terminal) of an embodiment, wherein an electric wire is not inserted into the structure in FIG. 1A and the electric wire is inserted into the structure in FIG. 1B;

FIG. 2 is a cross section taken along line B-B shown in FIG. 1B when viewed along an arrowheaded direction, showing that an electric wire is not inserted into the structure;

FIG. 3 is a cross sectional drawing showing the electric wire pinch structure with the electric wire inserted therein;

FIG. 4 is a drawing showing an exemplary modification of the electric wire pinch structure of the embodiment;

FIGS. 5A and 5B are drawings showing a related art electric wire pinch structure (a clamp terminal) wherein an electric wire is not inserted into the structure in FIG. 5A and the electric wire is inserted into the structure in FIG. 5B; and

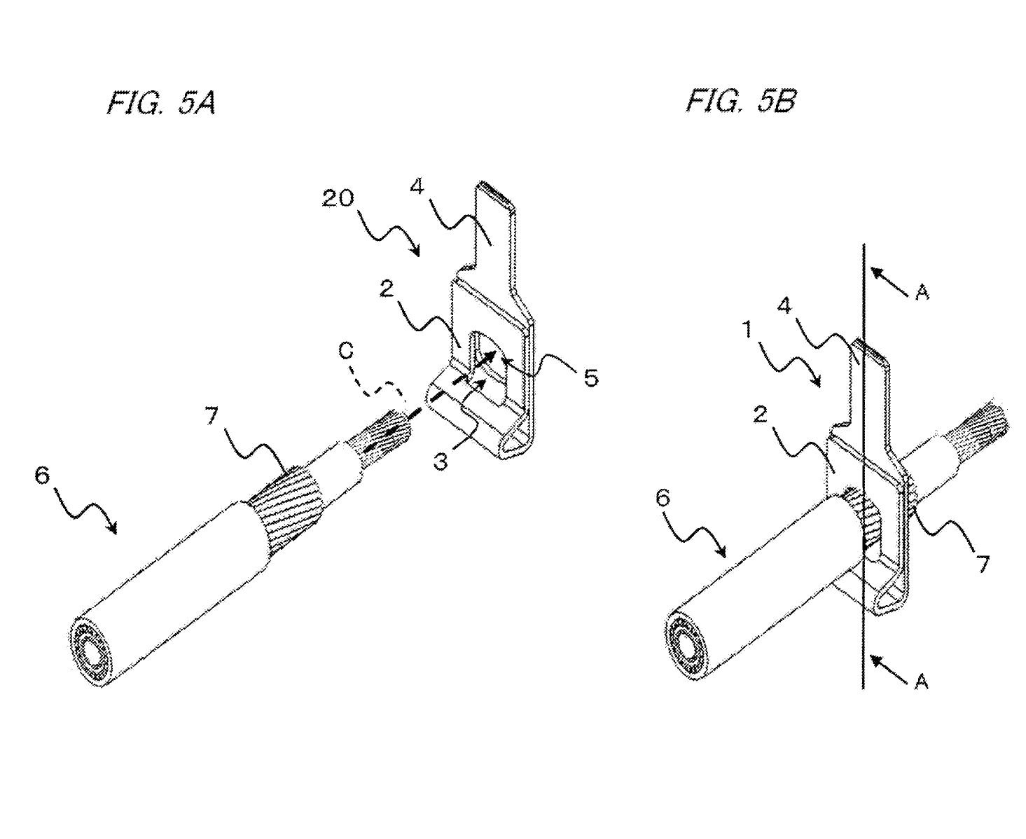

FIG. 6 is a cross section taken along line A-A shown in FIG. 5B when viewed along an arrowheaded direction, showing that the electric wire is inserted into the electric wire pinch structure.

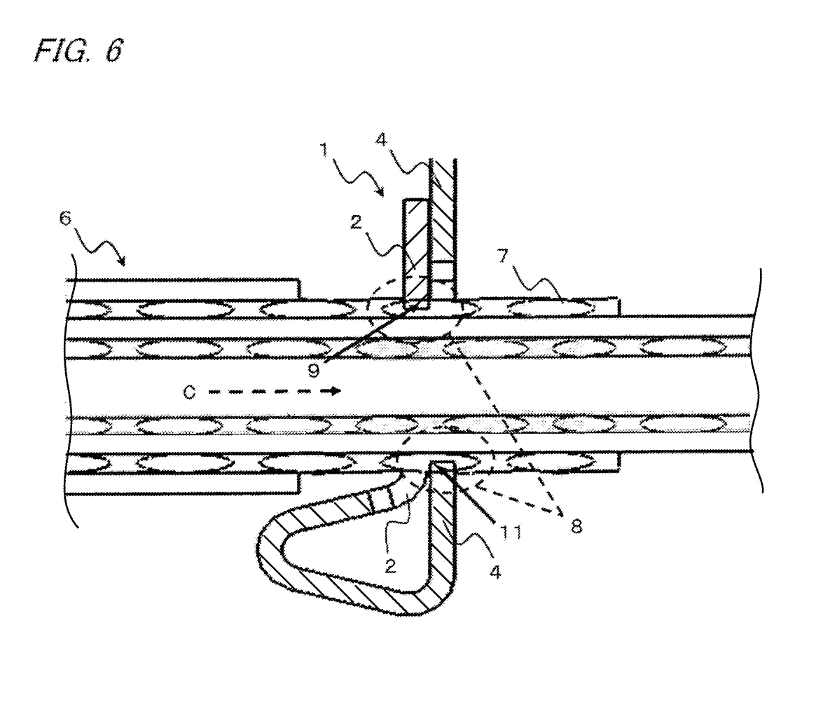

### DESCRIPTION OF EMBODIMENTS

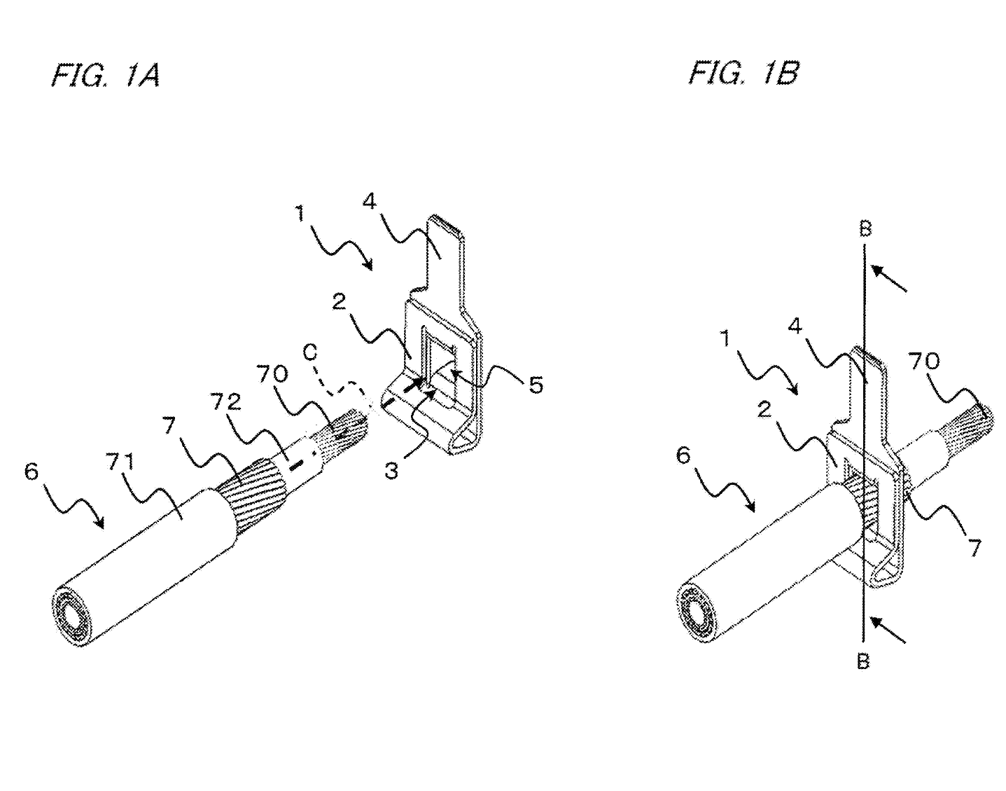

An electric wire pinch structure of an embodiment of the invention is hereunder described by reference to the drawings. FIGS. 1A and 1B are drawings showing an example of the electric wire pinch structure (a clamp terminal) of the embodiment. As shown in FIG. 1, the electric wire pinch structure (a clamp terminal) 1 has a flat plate (the first flat plate) 2 including an aperture (a first aperture) 3 into which an electric wire 6 is to be inserted and another flat plate (a second flat plate) 4 including another aperture (a second aperture) 5 into which the electric wire 6 is to be inserted. The electric wire 6 is inserted into the aperture (the first aperture) 3 and the other aperture (the second aperture) 5 along a direction C of insertion of the electric wire. The electric wire 6 includes a bare conductor (made up both of an external conductor 7 and of an internal conductor 70) and an insulating coating (made up both of an external insulating coating 71 and of an internal insulating coating 72). The external conductor 7 is sheathed with the external insulating coating 71. The internal insulating coating 72 exists between the external conductor 7 and the internal conductor 70. The internal conductor 70 remains bare forward of the external conductor 7 along the direction C of insertion. In a word, the external conductor 7, the internal insulating coating 72, and the internal conductor 70 are bare, in this sequence, along the direction C of insertion of the electric wire 6.

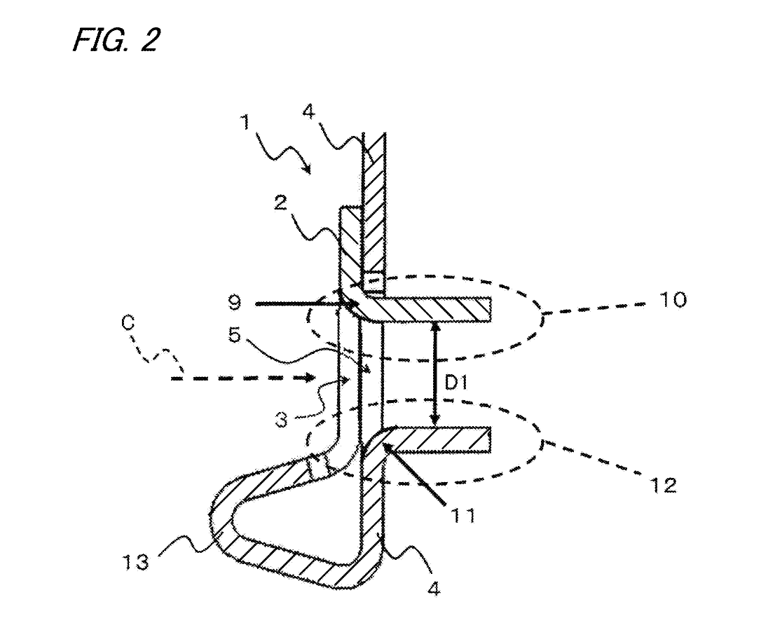

FIG. 2 is a cross section taken along line B-B shown in FIG. 1B when viewed along an arrowheaded direction, showing that the electric wire 6 is not inserted into the structure. As shown in FIG. 2, the electric wire pinch structure (a clamp terminal) 1 has a stretched area (a first stretched area) 10 that stretches from an upper side surface (a first side surface) 9 of the aperture (the first aperture) 3 along the direction C of insertion of the electric wire 6 and another stretched area (a second stretched area) 12 that stretches from a lower side surface (a second side surface) 11 of the other aperture (the second aperture) 5 in the direction C of insertion of the electric wire 6. The electric wire pinch structure (the clamp terminal) 1 has an urging section 13 for relatively sliding the flat plate (the first flat plate) 2 and the other flat plate (the second flat plate) 4.

In the embodiment, the urging section 13 is a curved area that connects the flat plate (the first flat plate) 2 and the other flat plate (the second flat plate) 4. A curved structure of the urging section 13 exerts elastic force on the flat plate (the first flat plate) 2 and the other flat plate (the second flat plate) 4 along their plane direction. A distance between the stretched area (the first stretched area) 10 and the other stretched area (the second stretched area) 12 is kept at D1 by dint of elastic force while the electric wire 6 is not inserted into the electric wire pinch structure 1.

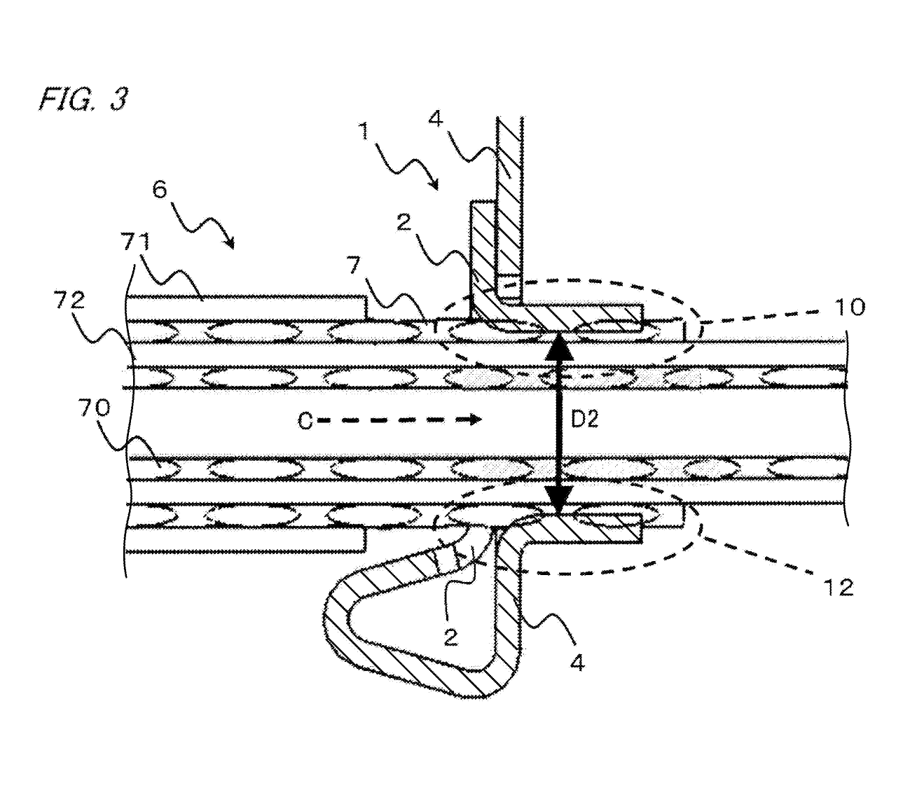

FIG. 3 is a cross sectional drawing showing the electric wire pinch structure 1 with the electric wire 6 inserted therein. When the electric wire 6 is inserted into the aperture (the first aperture) 3 and the other aperture (the second aperture) 5, force is exerted on the flat plate (the first flat plate) 2 and the other flat plate (the second flat plate) 4 along their plane direction, whereupon the urging section 13 is curved such that the distance between the stretched area (the first stretched area) 10 and the other stretched area (the second stretched area) 12 becomes increased. As a consequence, an aperture area where the aperture (the first aperture) 3 and the other aperture (the second aperture) 5 overlap each other becomes wider. The electric wire 6 is inserted in this state, and the internal conductor 70 and the internal insulating coating 72 thereupon pass through the aperture (the first aperture) 3 and the other aperture (the second aperture) 5. The external conductor (conductor) 7 then comes to situate between the stretched area (the first stretched area) 10 and the other stretched area (the second stretched area) 12.

When the external conductor 7 comes to situate at the stretched areas, the force exerted on the flat plate (the first flat plate) 2 and the other flat plate (the second flat plate) 4 along their plane direction, that is, a direction orthogonal to a direction of insertion of the electric wire in this embodiment, is released. The distance between the stretched area (the first stretched area) 10 and the other stretched area (the second stretched area) 12 will return to the distance D1 by dint of the elastic force of the urging section 13. Consequently, relative sliding arises in the plane direction between the flat plate (the first flat plate) 2 and the other flat plate (the second flat plate) 4. Thus, the electric wire 6 (the external conductor 7) is pinched at a distance D2 (D1<D2) between the stretched area (the first stretched area) 10 and the other stretched area (the second stretched area) 12. As shown in FIGS. 2 and 3, the stretched area (the first stretched area) 10 penetrates through the other aperture (the second aperture) 5, extending in the direction C of insertion of the electric wire 6. The upper side surface (the first side surface) 9 of the aperture (the first aperture) 3 and the lower side surface (the second side surface) 11 of the other aperture (the second aperture) 5 make up a curve.

The flat plate (the first flat plate) 2, the other flat plate (the second flat plate) 4, the upper side surface (the first side surface) 9 of the aperture 3, the stretched area (the first stretched area) 10, the lower side surface (the second side surface) 11 of the aperture 5, the stretched area (the second stretched area) 12, and the urging section 13 that make up the electric wire pinch structure (the damp terminal) 1 are formed from a conductive member into a single piece. The electric wire pinch structure (the damp terminal) 1 is easily manufactured by bending and cutting a conductor member piece. In particular, the stretched area (the first stretched area) 10 and the other stretched area (the second stretched area) 12 are formed by bending, in the direction C of insertion of the electric wire 6, regions that have been cut to make the aperture (the first aperture) 3 and the other aperture (the second aperture) 5.

As mentioned, according to the electric wire pinch structure 1 of the embodiment, the electric wire 6 is pinched not under the edge of the flat plate (the first flat plate) 2 and the edge of the other flat plate (the second flat plate) 4 but under flat portions of the stretched areas 10 and 12. Therefore, cutting of the electric wire 6 (the external conductor 7), which would otherwise be caused by pinching action, can be impeded, and a contact area between the external conductor 7 and the stretched areas 10 and 12 becomes larger, so that an electrical connection can be implemented without fail, and reliability of the electrical connection is enhanced. Further, as a result of the stretched areas 10 and 12 playing the role as a guide, the electric wire 6 can be smoothly inserted along the direction C of insertion. In addition, as a result of the stretched areas 10 and 12 playing the role as a guide, the electric wire 6 is inserted along the direction C of insertion without fail. Therefore, when a plurality of electric wires 6 are inserted, the electric wires 6 can be prevented from hindering insertion of other electric wires, or conductors (the external conductor 7 or the internal conductor 70) can be prevented from contacting each other.

The electric wire pinch structure 1 is easily fabricated by bending or cutting the conductive member piece, so that manufacturing costs can be kept low. In particular, since the stretched areas 10 and 12 are made by bending the regions that are cut to make the apertures 3 and 5, waste of an electrically-operated member can be eliminated, so that the manufacturing cost can be kept low.

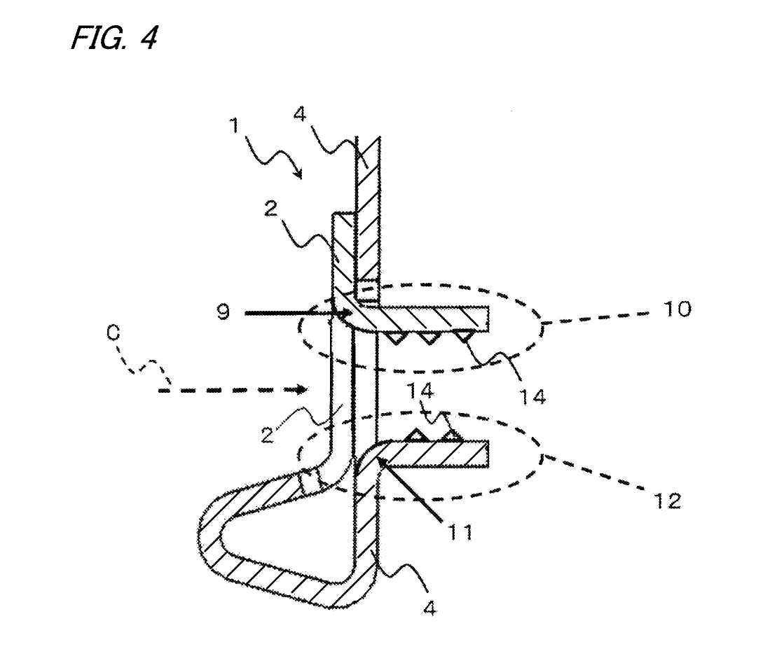

FIG. 4 is a drawing showing an exemplary modification of the electric wire pinch structure of the embodiment. As shown in FIG. 4, the electric wire pinch structure (the clamp terminal) 1 can also have projections 14 that are provided on at lease one of the surface of the stretched area (the first stretched area) 10 and the surface of the other stretched area (the second stretched area) 12 to contact the electric wire 6 (the external conductor 7). The projections 14 come into contact the external conductor 7, which can incur an increase in frictional coefficient. Thus, the pinched external conductor 7 can be fastened without fail.

The embodiment of the invention has been described thus far. However, the invention is not restricted to the embodiment and susceptible to alterations or modifications within the scope of claims.

For instance, in the embodiment, the first side surface is the upper side surface of the aperture 3, and the second side surface is the lower side surface of the aperture 5. However, the first side surface can also be a lower side surface of the aperture 3, and the second side surface can also be an upper side surface of the aperture 5, so long as the minimum requirement that the first stretched area 10 and the second stretched area 12 be set so as to face each other should be fulfilled.

In the embodiment, the first flat plate 2 and the second flat plate 4 are contiguous to each other, they can be separated from each other. Moreover, a spring or an elastic element can also be used for the urging section 13.

The present application is based on Japanese patent application No. 2012-106275 filed on May 7, 2012, and the contents of the patent application are incorporated herein by reference.

### INDUSTRIAL APPLICABILITY

The electric wire pinch structure of the invention can prevent cutting of the electric wire, which would otherwise be caused by pinching action, and an electrical connection can be made more reliable by increasing the contact area of the conductor. Thus, the invention is useful as an electric wire pinch structure used for a terminal that brings a conductor of an electric wire into an electrical connection.

### REFERENCE SIGNS LIST

1 Electric Wire Pinch Structure
2 First Flat Plate
3 First Aperture
4 Second Flat Plate
5 Second Aperture
6 Electric Wire
7 External Conductor
9 First Side Surface
10 First Stretched Area
11 Second Side Surface
12 Second Stretched Area
13 Urging Section
14 Projection
70 Internal Conductor
71 External Insulating Coating
72 Internal Insulating Coating

1. An electric wire pinch structure comprising:
a first flat plate having a first side surface partly forming a first aperture into which an electric wire is to be inserted;
a second flat plate having a second side surface partly forming a second aperture into which the electric wire is to be inserted;
a first stretched area that extends from the first side surface of the first aperture along a direction of insertion of the electric wire; and
a second stretched area that extends from the second side surface of the second aperture in the direction of insertion of the electric wire, wherein
the electric wire is pinched between the first stretched area and the second stretched area as a result of relative sliding taking place between the first flat plate and the second flat plate a direction orthogonal to a direction of insertion of the electric wire.

2. The electric wire pinch structure according to claim 1, wherein the first stretched area penetrates through the second aperture, to thus extend in the direction of insertion of the electric wire.

3. The electric wire pinch structure according to claim 2, further comprising:
projections that are provided on at least one of a surface of the first stretched area and a surface of the second stretched area to contact the electric wire.

4. The electric wire pinch structure according to claim 3, further comprising:
an urging section for relatively sliding the first flat plate and the second flat plate.
